(19) United States
(12) Patent Application Publication
(10) Pub. No.: US 2025/0356717 A1
(43) Pub. Date: Nov. 20, 2025

(54) LAUNDRY APPLIANCE TRANSACTION METHODS

(71) Applicant: Haier US Appliance Solutions, Inc., Wilmington, DE (US)

(72) Inventors: MyungGeon Chung, Seoul (KR); Abdelghani Elfarra, Louisville, KY (US)

(21) Appl. No.: 18/668,992

(22) Filed: May 20, 2024

(51) Int. Cl. G06Q 30/0601; G06Q 20/40

(52) U.S. Cl. CPC G06Q 30/0609; G06Q 20/40; G06Q 30/0633

(57) ABSTRACT

Methods of operating a laundry appliance include receiving an offer for sale of a laundry article. The offer is received from a first user. Methods may also include receiving an access request for the laundry appliance, from either the first user or a second user. Methods may further include activating the laundry appliance in response to the access request, which causes the laundry appliance to perform a laundry treatment operation. Some methods may include determining the laundry treatment operation is within a completion threshold and causing a notification to be presented to the second user that the laundry treatment operation is within the completion threshold. Some methods may include causing a confirmation prompt to be presented to the second user, receiving a payment authorization, and applying a credit to the first user's account in response to the payment authorization.

### FIELD OF THE INVENTION

The present subject matter relates generally to systems and methods for coordinating transactions of one or more laundry articles with treatment cycles for a load of such articles in a laundry appliance.

### BACKGROUND OF THE INVENTION

Laundry appliances generally include washing machine appliances and dryer appliances. Some laundry appliances are publicly available, such as commercial laundry appliances available for rent, e.g., in a laundromat.

Secondhand trading platforms by which one user can sell used goods directly to another user (e.g., as opposed to donating or consigning the goods) have become increasingly popular in recent years. Transactions conducted over such platforms have some drawbacks. For example, the buyer and seller must arrange a location to meet in order to complete the transaction, and it can be difficult to find a safe and mutually convenient location. As another example, the buyer has no guarantee of the quality or condition of the goods being purchased, such as whether secondhand clothing has been recently laundered or adequately cleaned.

Thus, systems and methods for coordinating laundry item transactions with laundry treatment operations in a public laundry facility such as a laundromat would be beneficial and are desired in the art.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating a laundry appliance is provided. The method includes receiving an offer for sale of a laundry article. The offer is received from a first remote user interface device associated with a first user account. The method also includes receiving an access request for the laundry appliance from the first remote user interface device. In response to the access request, the laundry appliance is activated. Activating the laundry appliance includes causing the laundry appliance to perform a laundry treatment operation. The method also includes determining the laundry treatment operation is within a completion threshold. The method further includes causing a notification to be presented on a second remote user interface device associated with a second user account that the laundry treatment operation is within the completion threshold.

In accordance with another embodiment of the present disclosure, a method of operating a laundry appliance is provided. The method includes receiving an offer for sale of a laundry article. The offer is received from a first remote user interface device associated with a first user account. The method also includes receiving an access request for the laundry appliance from a second remote user interface device associated with a second user account. In response to the access request, the laundry appliance is activated. Activating the laundry appliance includes causing the laundry appliance to perform a laundry treatment operation. The method also includes causing a confirmation prompt to be presented on the second remote user interface device and receiving a payment authorization from the second remote user interface device in response to the confirmation prompt. The method further includes applying a credit to the first user account in response to the payment authorization.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a schematic diagram of a laundry appliance in communication with a remote user interface device and a remote computing device according to one or more embodiments of the present disclosure.

FIG. 5 provides a flowchart illustrating an example method of operating a laundry appliance according to one or more embodiments of the present disclosure.

FIG. 6 provides a flowchart illustrating another example method of operating a laundry appliance according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

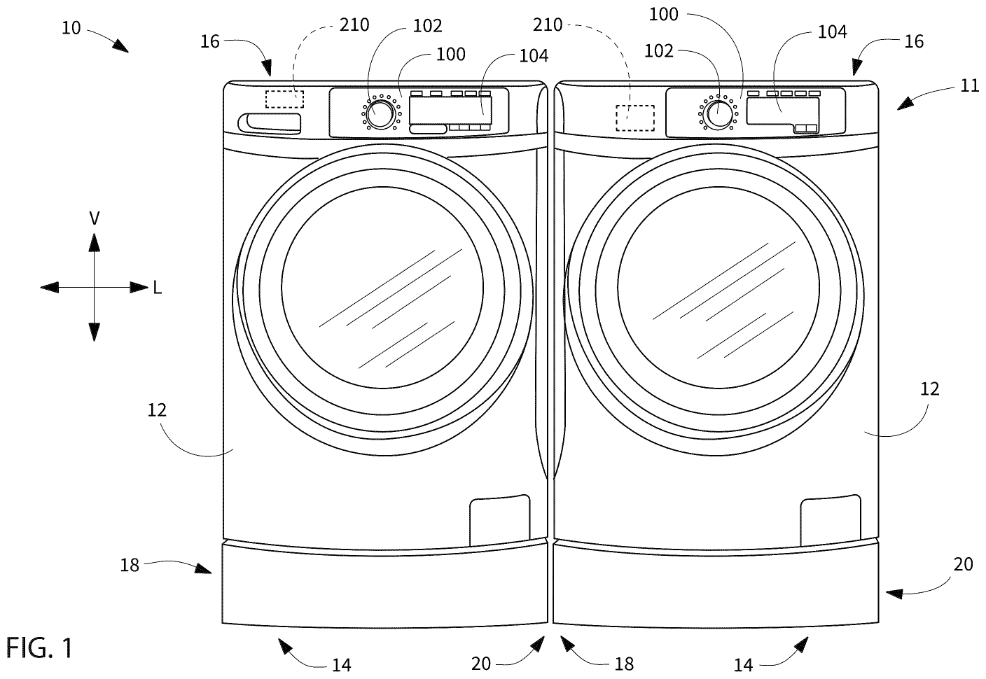

Exemplary laundry appliances are illustrated in FIGS. 1 through 3, e.g., a washing machine appliance and a dryer appliance. In various embodiments of the present subject matter, a laundry appliance may be any suitable laundry appliance, such as a washing machine appliance, a dryer appliance, a combination washer-dryer appliance, etc.

As may be seen generally throughout FIGS. 1 through 3, a user interface panel 100 and a user input device 102 may be positioned on an exterior of the laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g., performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, a laundry appliance may be a washing machine appliance 10 or a dryer appliance 11, and a group of laundry appliances may include multiple washing machine appliances 10 and/or multiple dryer appliances 11. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each household appliance 10 and 11.

As generally seen throughout FIGS. 1 through 3, in at least some embodiments, each laundry appliance 10 and 11 includes a cabinet 12 which defines a vertical direction V, a lateral direction L, and a transverse direction T that are mutually perpendicular. Each cabinet 12 extends between a top side 16 and a bottom side 14 along the vertical direction V. Each cabinet 12 also extends between a left side 18 and a right side 20, e.g., along the lateral direction L, and between a front side 22 and a rear side 24 along the transverse direction T.

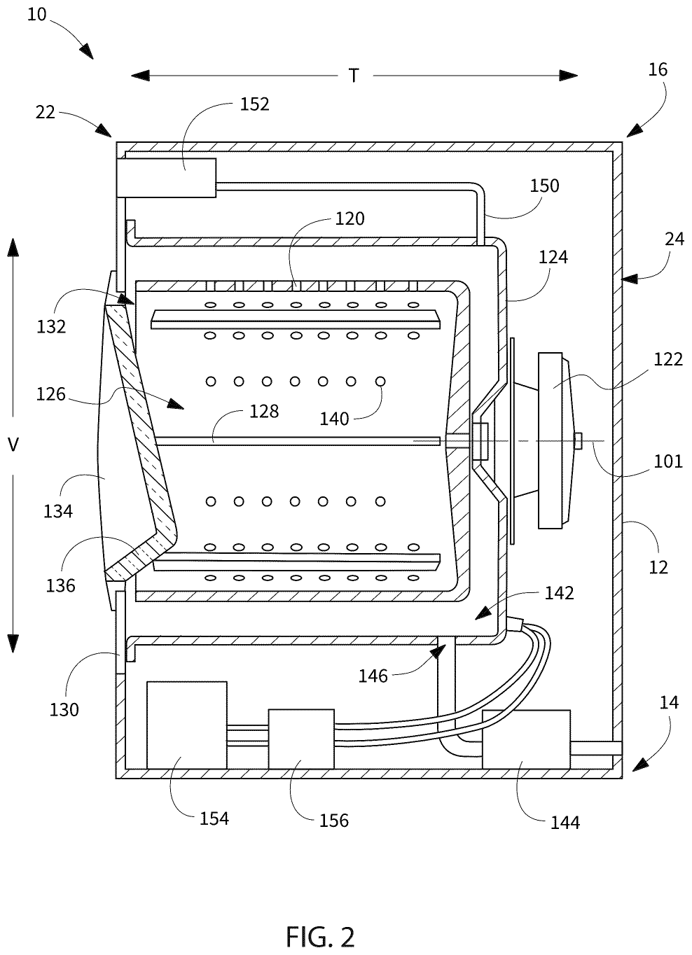

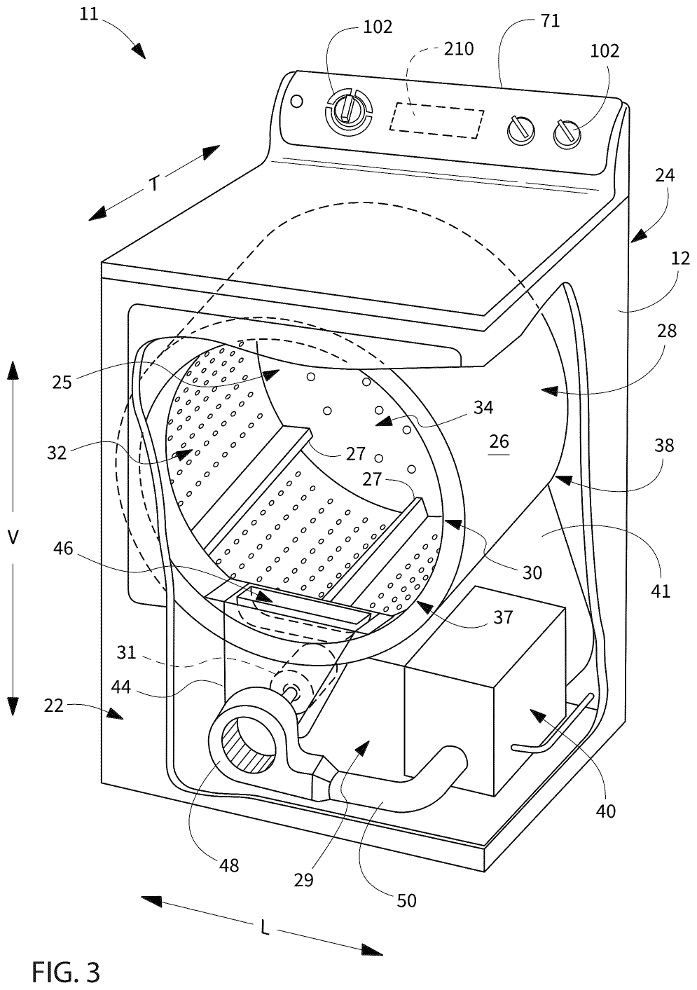

Additional exemplary details of each laundry appliance are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a laundry appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

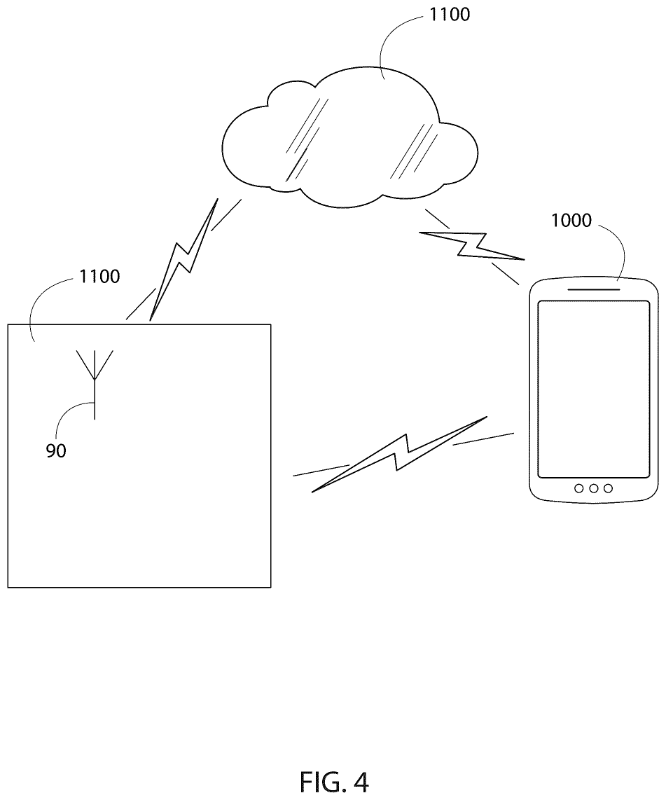

Turning now to FIG. 4, a general schematic of a laundry appliance 1002, which may be, e.g., the washing machine appliance 10 or the dryer appliance 11 described above, and communication features thereof is provided. FIG. 4 schematically illustrates a laundry appliance 1002, which may be, for example, one of the laundry appliances 10 or 11 of FIGS. 1 through 3, among other possible example laundry appliances, which communicates wirelessly with a remote user interface device 1000. For example, as illustrated in FIG. 4, the laundry appliance 1002 may include an antenna 90 by which the laundry appliance 1002 communicates with, e.g., sends and receives signals to and from, the remote user interface device 1000. The laundry appliance 1002 may communicate with the remote user interface device 1000 over a direct wireless communication link or over an indirect wireless communication link, such as via a remote server, a network, or cloud 1100. The remote user interface device 1000 may be a laptop computer, smartphone, tablet, personal computer, wearable device, smart home system, and/or various other suitable devices.

The laundry appliance 1002 may be in communication with the remote user interface device 1000 device through various possible communication connections and interfaces. The laundry appliance 1002 and the remote user interface device 1000 may be matched in wireless communication, e.g., connected to the same wireless network. The laundry appliance 1002 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the laundry appliance 1002, e.g., the remote user interface device 1000 is a separate, stand-alone device from the laundry appliance 1002 which communicates with the laundry appliance 1002 wirelessly. Any suitable device separate from the laundry appliance 1002 that is configured to provide and/or receive communications, information, data, or commands from a user may serve as the remote user interface device 1000, such as a smartphone (e.g., as illustrated in FIG. 4), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

As mentioned above, the laundry appliance 1002 may also be configured to communicate wirelessly with the cloud 1100, e.g., one or more remote computing devices, such as a remote database, remote server, etc., in a distributed computing environment. Such distributed computing environments may include, for example, cloud computing, fog computing, and/or edge computing. For example, the cloud 1100 may be or include a remote database which may be, e.g., a cloud-based data storage system. For example, the laundry appliance 1002 may communicate with the cloud 1100 over the Internet, which the laundry appliance 1002 may access via WI-FI®, such as from a WI-FI® access point in a user's home.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

In some embodiments, the performance of exemplary methods and associated method steps as disclosed herein may be distributed, e.g., performed in part by the controller 210 and in part by one or more remote computing devices in the cloud 1100 and/or remote user interface device 1000.

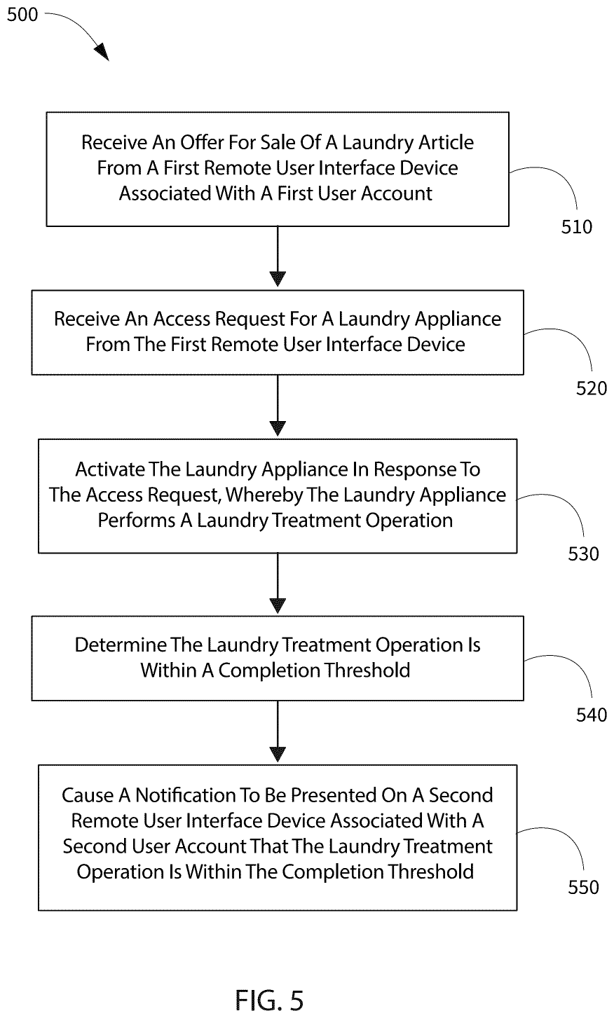

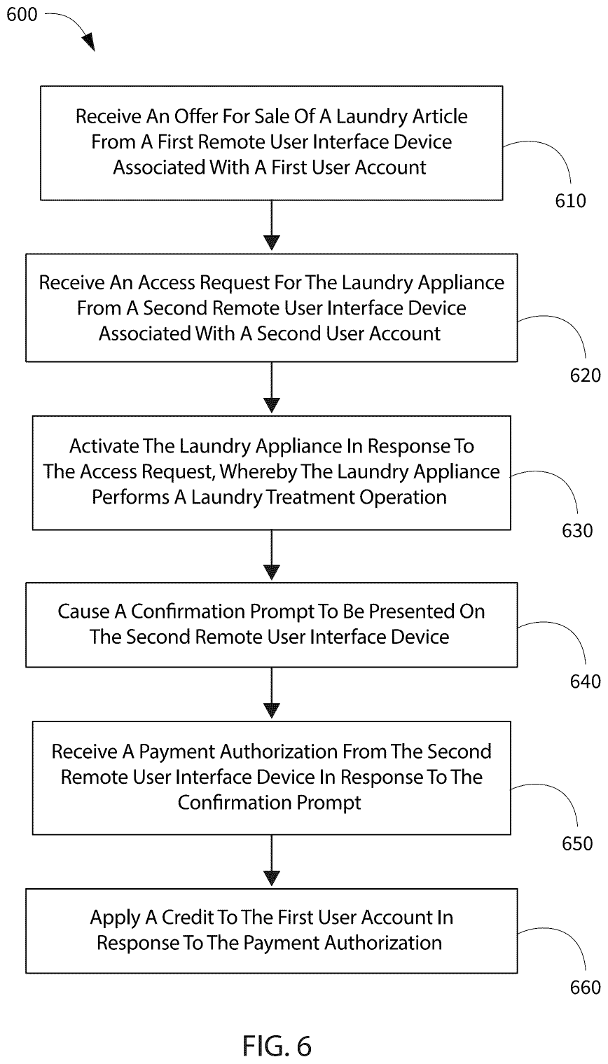

As illustrated in FIGS. 5 and 6, embodiments of the present disclosure also include methods of operating a laundry appliance, e.g., one of the laundry appliances described above, such as washing machine appliance 10 or dryer appliance 11, among other possible exemplary laundry appliances, such as a washer-dryer combination appliance. Exemplary methods according to the present subject matter include the method 500 illustrated in FIG. 5 and the method 600 illustrated in FIG. 6. Methods such as method 500 and/or method 600 can be used to operate any suitable laundry appliance. For example, such methods may be utilized to operate washing machine appliance 10 or dryer appliance 11 (FIGS. 1 through 3). Controller 210 of laundry appliance 10 or 11 may be programmed to implement method 500 and/or method 600, e.g., controller 210 is capable of and may be operable to perform any methods and associated method steps as disclosed herein. In some embodiments, the controller 210 may perform method steps in combination with one or more remote computing devices, such as a remote database or remote processor or one or more other remote computing devices, e.g., in a distributed computing environment such as the cloud, the fog, and/or the edge. Thus, references herein to a “remote computing device” include at least one such device with which a laundry appliance and/or remote user interface device communicates, e.g., over the internet, such as one or more remote computing devices in the cloud, etc. In such embodiments, the controller 210 may communicate with such remote computing device or devices via the internet, among other possible communications means. For example, some embodiments of the methods disclosed herein may include distributed computing whereby certain steps or calculations/determinations are performed locally, e.g., by the controller 210 onboard the laundry appliance 10 or 11, while other steps or calculations/determinations are performed by a remote computing device with which the controller 210 communicates, e.g., via the internet.

Turning now to FIG. 5 in particular, in some embodiments methods of operating a laundry appliance such as method 500 may include (510) receiving an offer for sale of a laundry article from a first remote user interface device associated with a first user account. Thus, in such embodiments, the first user may be a seller of the laundry article (or more than one laundry article), such that the first user account may also be referred to as a seller account. Such nomenclature is for purposes of illustrating an exemplary transaction only and is not limiting, e.g., the seller account is the seller in the exemplary transaction(s) described herein, but the first user account is not limited to only selling, e.g., in additional transactions the first user account may be a buyer account. As used herein, a remote user interface device may be “associated with” a user account in that the user is logged into the user account on the remote user interface device and the remote user interface may have been commissioned to the user account, e.g., verified or authorized to access the user account, in the cloud or other remote computing system or device.

In some embodiments, the offer for sale of the laundry article may include a laundromat location, or multiple laundromat locations. For example, the laundromat location(s) may be selected by the seller based on the seller's location, e.g., residence, such as the one or more laundromats which are identified by location in the offer for sale may be the laundromats at which the seller is willing and able to complete the transaction, such as the laundromat(s) at which the seller regularly does laundry and/or are otherwise selected by the first user (e.g., the seller in this example transaction). As will be discussed further below, exemplary methods according to the present disclosure such as method 500 may also include activating a laundry appliance and, in such embodiments, the laundry appliance which is activated may be located in or at the laundromat (or one of the laundromats) identified by location in the offer for sale.

The offer for sale may be received by a remote computing device, e.g., in the cloud as described above. The remote computing device may receive multiple offers for sale of various laundry articles from one or more remote user interface devices and may compile such offers into a list or for sale board. Thus, for example, some embodiments of method 500 may include generating a list of laundry articles for sale, and the generated list may include the laundry article. The for sale list may be presented to additional users via remote computing devices associated with additional user accounts, e.g., associated in the cloud as described above. The list or for sale board may be sorted, e.g., by laundromat locations in embodiments where the offer for sale includes one or more laundromat locations. For example, in such embodiments, the for sale board may be presented to additional users who have previously accessed one or more laundry appliances in the specified laundromat and/or when the additional users access such laundry appliances, e.g., the remote computing device may transmit the for sale list to one or more user interface devices associated with the user accounts of such additional users. A laundry app running on, e.g., the smartphones associated with such additional user accounts may, for example, cause the for sale board to be displayed on the remote user interface device (e.g., smartphone) when the laundry app is active, and/or via a pop-up or push notification, in various embodiments.

Still referring to FIG. 5, method 500 may further include (520) receiving an access request for the laundry appliance from the first remote user interface device. The access request may be or may include, for example, a reservation request, a payment for a cycle of the laundry appliance, an unlock command, and/or a start command. In general, the access request may be any suitable interaction from the first remote user interface device and/or the first user account with the laundry appliance by which it may be indicated or determined that the first user, e.g., seller, has accessed or is intending to access the particular laundry appliance. The request may be received from the first user, e.g., who is logged into the first user account, such as in a laundry app. The access request may be received via the first remote user interface device, such as the remote user interface device 1000 described above, where the first remote user interface device may be running the laundry app. For example, the first user may input the access request via the first remote user interface device associated with the first user account, and the access request for the laundry appliance may be received, e.g., by controller 210 and/or a remote computing device 1100, from the first remote user interface device associated with the first user account.

Method 500 may further include (530) activating the laundry appliance, e.g., initiating an operation cycle of the laundry appliance, in response to the access request. Activating the laundry appliance causes the laundry appliance to perform a laundry treatment operation. The laundry treatment operation may be any laundry cycle, such as a wash cycle in washing machine appliance, a dry cycle in a dryer appliance, or both in a combination laundry appliance, among other possible laundry cycles. Performing the laundry treatment operation, e.g., in (530) of method 500, includes causing at least one mechanical component of the laundry appliance to be operated. For example, the mechanical component may be a motor, such as the motor 122 of the washing machine appliance or the motor 31 of the dryer appliance, a fan, a heating element, a pump, a compressor, or a valve, among other possible example mechanical components of a laundry appliance. Also, operating the mechanical component includes changing a physical status of the component, e.g., a speed, position, etc. of the component, such as accelerating the motor, fan, etc., e.g., from a zero starting speed, opening a valve, and/or other changes in the physical state of one or more mechanical components of the laundry appliance.

Method 500 may further include (540) determining the laundry treatment operation is within a completion threshold. In various embodiments, the completion threshold may be a percentage, such as a minimum percentage of the overall laundry treatment operation, or a time, such as a minimum remaining time until completion of the laundry treatment operation, or other similar completion threshold. For example, the completion threshold may be about fifteen minutes, and determining that the operation cycle is within the completion threshold may include determining that there is fifteen minutes (or other completion threshold time) remaining in the operation cycle.

As illustrated in FIG. 5, method 500 may further include (550) causing a notification to be presented on a second remote user interface device associated with a second user account that the laundry treatment operation is within the completion threshold. Thus, the second user, e.g., buyer, may be notified that the laundry article is available to be inspected and/or purchased, and the buyer may also be assured that the laundry article is clean by virtue of the laundry article having just been treated in the laundry appliance.

In some embodiments, the second user account may be one of the additional user accounts described above to which the for sale board was presented. Some embodiments of method 500 may further include receiving a request for the laundry article from the second remote user interface device before activating the laundry appliance. For example, the request for the laundry article may be a request to buy the laundry article and may be received in response to the for sale board having been presented on the second remote user interface device. The request for the laundry article may be received, e.g., by a remote computing device, from the second remote user interface device. For example, the buyer may select the laundry article (and one or more additional laundry articles for sale from the same seller or other sellers, e.g., other sellers at the same laundromat) from the for sale board via the second remote user interface device, such that the request for the laundry article may be or may include a selection of the laundry article from the for sale board on the second remote user interface device.

The buyer may be charged for the laundry article, and the seller may be paid for the laundry article. Such charges and payments may be handled, for example, in an application or “app,” e.g., on each of the first remote user interface device and the second remote user interface device, such as first and second smartphones, and the transaction may be mediated in a remote computing device and/or distributed computing environment. For example, money may be withdrawn from the buyer's account via the app and money may be credited to the seller's account via the app, where each such account may be maintained in the remote computing device, e.g., cloud. In some embodiments, a processing fee or surcharge may be added to the price of the laundry article, e.g., the amount withdrawn from the buyer's account may be not the same as the amount credited to the seller's account, e.g., the amount withdrawn may be higher due to the inclusion of the processing fee and/or the amount credited may be lower after deducting a commission or processing fee, etc. Such surcharges may be set amounts or may be proportional to (e.g., a percentage of) the amount of the transaction.

In some embodiments, the credit may not be transferred unless or until the buyer is satisfied and/or confirms that the sale was completed and the articles are in acceptable condition. For example, one or more exemplary methods according to embodiments of the present disclosure may include causing a confirmation prompt to be presented on the second remote user interface device after completing the laundry treatment operation. The affirmative response may include, for example, a selection, such as a tap, on a “Yes” option in the prompt or other similar affirmative option, e.g., a green light, thumbs up icon, etc. By providing an affirmative response to the confirmation prompt, e.g., via the second remote user interface device, the buyer may confirm the laundry article is as described, is in acceptable condition, and that the transaction may proceed. In such embodiments, the method may further include receiving a payment authorization from the second remote user interface device in response to the confirmation prompt. Such embodiments may also include applying a credit to the first user account, e.g., the account with which the first remote user interface device is associated, e.g., in the cloud, in response to the payment authorization.

In some embodiments, the laundry appliance which is activated, e.g., at (530) in FIG. 5, may be a dryer appliance. In such embodiments, method 500 may further include receiving an access request for a washing machine appliance from the first remote user interface device, e.g., before the access request for the dryer appliance. Such embodiments may also include activating the washing machine appliance which causes the washing machine appliance to performs a wash cycle. Also in such embodiments, method 500 may include causing a notification to be presented on the second remote user interface device that the wash cycle is complete before activating the dryer appliance. For example, such notification may inform the second user, e.g., buyer, that the treatment, e.g., cleaning, e.g., washing and drying, of the article for sale is in progress and may also provide an estimated completion time for the treatment of the laundry article, at which time the laundry article may be available for inspection and/or purchase.

An additional exemplary method 600 of operating a laundry appliance is illustrated in FIG. 6. In general, method 500 may include treating, e.g., washing and/or drying, the laundry article by the seller before the transaction is completed, whereas method 600 may include treating, e.g., washing and/or drying, the laundry article by the buyer. For example, methods such as the exemplary method 600 may permit the buyer to wash the laundry articles with a full load of articles, e.g., rather than having to wash the article by itself.

As illustrated in FIG. 6, in some embodiments, method 600 may include (610) receiving an offer for sale of a laundry article from a first remote user interface device associated with a first user account, e.g., the first user account may be owned and managed by a first user, e.g., seller of the laundry article in this example. Receiving at (610) may be performed and implemented similarly to (510) of method 500 as described above.

Method 600 may further include (620) receiving an access request for the laundry appliance from a second remote user interface device associated with a second user account. The access request in (620) may take any of the forms described above with respect to (520) in method 500 as illustrated in FIG. 5. In a similar manner as described above regarding (530) in method 500 of FIG. 5, method 600 may include activating the laundry appliance in response to the access request, which causes the laundry appliance to perform a laundry treatment operation.

Method 600 may further include (640) causing a confirmation prompt to be presented on the second remote user interface device, (650) receiving a payment authorization from the second remote user interface device in response to the confirmation prompt, and (660) applying a credit to the first user account in response to the payment authorization. That is, method 600 may include one or more similar verification and approval processes, e.g., whereby the buyer has an opportunity to inspect the laundry article before purchasing, as described above with respect to embodiments of method 500. In the context of method 600, e.g., where the buyer causes the laundry appliance to treat, e.g., wash and/or dry, the laundry article, such confirmation may be performed before the laundry treatment operation in some embodiments, e.g., whereby the seller receives payment before relinquishing possession of the laundry article, or may be performed after the laundry treatment operation, e.g., whereby the buyer has a full opportunity to ensure the laundry article is in a condition acceptable to the buyer and is clean before completing the transaction.

For example, in some embodiments of method 600, the payment authorization may be received and the credit may be applied to the first user account after completion of the laundry treatment operation. In such embodiments, the method may also include determining the laundry treatment operation is within a completion threshold and causing a notification to be presented on the first remote user interface device that the laundry treatment operation is within the completion threshold. Thus, for example, the seller may leave the laundromat while the buyer washes and dries the laundry article (or the seller may do his or her own laundry, etc., where the seller is not required to be present during the laundry treatment operation initiated by the buyer, e.g., initiated in response to one or more commands or other inputs from the second remote user interface device associated with the second user account). In such embodiments, the laundry appliance may be a dryer appliance, e.g., such that the completion of the laundry treatment operation in the dryer appliance also completes the overall treatment, e.g., both washing and drying, of the laundry article.

In additional embodiments, the payment authorization may be received and the credit may be applied to the first user account before activating the laundry appliance. In such embodiments, the laundry appliance may be a washing machine appliance. Thus, for example, if the buyer finds the laundry article acceptable and agrees to complete the transaction before treating, e.g., washing, the laundry article, the seller may be paid before the treatment process begins at all, e.g., before washing the laundry article in such embodiments.

Referring now generally to FIGS. 5 and 6, the methods 500 and/or 600 may be interrelated and/or may have one or more steps from one of the methods 500 and 600 combined with the other method 500 or 600. Thus, those of ordinary skill in the art will recognize that the various steps of the exemplary methods described herein may be combined in various ways to arrive at additional embodiments within the scope of the present disclosure. For example, embodiments of method 600 may also include a specified location for the laundry article for sale and/or generating a list or for sale board of laundry articles including the laundry article, and various other aspects described above with respect to embodiments of method 500 may also be applied to method 600.

FIGS. 5 and 6 depict steps in a particular order for purpose of illustration and discussion. Those of ordinary skill in the art, using the disclosures provided herein, will understand that (except as otherwise indicated) methods 500 and 600 are not mutually exclusive. Moreover, the steps of the methods 500 and 600 can be modified, adapted, rearranged, omitted, interchanged, or expanded in various ways without deviating from the scope of the present disclosure.

Furthermore, the skilled artisan will recognize the interchangeability of various features from different embodiments. Similarly, the various method steps and features described, as well as other known equivalents for each such method and feature, can be mixed and matched by one of ordinary skill in this art to construct additional systems and techniques in accordance with principles of this disclosure. Of course, it is to be understood that not necessarily all such objects or advantages described herein may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Aspects of the present disclosure include methods to exchange secondhand clothing using a mobile application (e.g., an app on a remote user interface device such as a smartphone) through a laundromat. The mobile application may allow a first user, e.g., seller, to upload a photo of clothes with description and a time at which the seller is expected to wash the laundry at the laundromat. A sales board may be provided and may list all the clothes that one or more sellers have posted in the specific laundromat, and may show the post to a group of buyers. The group of buyers may be identified or defined, for example, based on location through the mobile application and/or based on current or past use of the same laundromat. In some embodiments, when a buyer selects to buy a particular clothing article, a push notification about the start and finish time of a laundry cycle initiated by the seller is sent to the buyer, so that the buyer meets the seller at the respective time, checks the condition of the clothes, makes a decision to buy the used clothes and pays the bill through the mobile application. In additional embodiments, e.g., when the buyer is not available at the time the seller finishes the laundry, the buyer may set an expected time for a laundry cycle to be initiated by the buyer and the sale of clothes may be finalized after checking the condition of the clothes. In such embodiments, the seller gets one or more push notifications about a time of the buyer-initiated laundry treatment operation, e.g., the start time and/or the finishing time of the buyer-initiated laundry treatment operation. For example, when the buyer pays for the clothing article before washing, the seller push notification may be about a start time, or, in another example, when the buyer wishes to fully treat, e.g., wash and dry, the clothing before confirming the purchase, the notification to the device associated with the seller's account may be about the finishing time of the buyer-initiated laundry treatment operation (which may be, e.g., a drying operation in a dryer appliance in such embodiments). This method may generate revenue in the form of commission fees for trading used clothes, e.g., such fees may be collected by a remote computing system such as a cloud system owned and/or operated by a manufacturer of the laundry appliance or by the owner of the laundromat.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a laundry appliance, the method comprising:
receiving an offer for sale of a laundry article from a first remote user interface device associated with a first user account;
receiving an access request for the laundry appliance from the first remote user interface device;
activating the laundry appliance in response to the access request, whereby the laundry appliance performs a laundry treatment operation;
determining the laundry treatment operation is within a completion threshold; and
causing a notification to be presented on a second remote user interface device associated with a second user account that the laundry treatment operation is within the completion threshold.

2. The method of claim 1, further comprising causing a confirmation prompt to be presented on the second remote user interface device after completing the laundry treatment operation.

3. The method of claim 2, further comprising receiving a payment authorization from the second remote user interface device in response to the confirmation prompt.

4. The method of claim 3, further comprising applying a credit to the first user account in response to the payment authorization.

5. The method of claim 1, wherein the laundry appliance is a dryer appliance.

6. The method of claim 5, further comprising receiving an access request for a washing machine appliance from the first remote user interface device, activating the washing machine appliance whereby the washing machine appliance performs a wash cycle, and causing a notification to be presented on the second remote user interface device that the wash cycle is complete before activating the dryer appliance.

7. The method of claim 1, wherein the offer for sale of the laundry article includes a laundromat location, wherein the laundry appliance is located at the laundromat.

8. The method of claim 1, further comprising generating a list of laundry articles for sale, the list including the laundry article.

9. The method of claim 1, further comprising receiving a request for the laundry article from the second remote user interface device before activating the laundry appliance.

10. A method of operating a laundry appliance, the method comprising:
receiving an offer for sale of a laundry article from a first remote user interface device associated with a first user account;
receiving an access request for the laundry appliance from a second remote user interface device associated with a second user account;
activating the laundry appliance in response to the access request, whereby the laundry appliance performs a laundry treatment operation;
causing a confirmation prompt to be presented on the second remote user interface device;
receiving a payment authorization from the second remote user interface device in response to the confirmation prompt; and
applying a credit to the first user account in response to the payment authorization.

11. The method of claim 10, wherein the payment authorization is received and the credit is applied to the first user account after completion of the laundry treatment operation.

12. The method of claim 11, further comprising determining the laundry treatment operation is within a completion threshold and causing a notification to be presented on the first remote user interface device that the laundry treatment operation is within the completion threshold.

13. The method of claim 11, wherein the laundry appliance is a dryer appliance.

14. The method of claim 10, wherein the payment authorization is received and the credit is applied to the first user account before activating the laundry appliance.

15. The method of claim 14, wherein the laundry appliance is a washing machine appliance.

16. The method of claim 10, wherein the offer for sale of the laundry article includes a laundromat location, wherein the laundry appliance is located at the laundromat.

17. The method of claim 10, further comprising generating a list of laundry articles for sale, the list including the laundry article.
